(19) United States
(12) Patent Application Publication
(10) Pub. No.: US 2002/0063939 A1
(43) Pub. Date: May 30, 2002

(54) Optical scanning apparatus

(76) Inventors: Jae-yong Eum, Gyeonggi-do (KR); Hwan-young Choi, Gyeonggi-do (KR); Moon-gyu Lee, Gyeonggi-do (KR); Sung-min Cho, Seoul (KR)

Correspondence Address: STAAS & HALSEY LLP, 700 11TH STREET, NW, SUITE 500, WASHINGTON, DC, 20001, US

(21) Appl. No.: 09/978,307

(22) Filed: Oct. 17, 2001

(30) Foreign Application Priority Data
Oct. 20, 2000 (KR) 2000-61984

(51) Int. Cl. G02B 26/08; B41J 27/00; G02F 1/03; G02F 1/07

(52) U.S. Cl. 359/205; 359/216; 347/259; 359/261

(57) ABSTRACT

An optical scanning apparatus which is improved in color registration by reducing bow of a scan line which is formed on a photosensitive medium. A plate having a slit with a width appropriate for a spot size of a scan line and a length corresponding to a predetermined scanning length is interposed between the photosensitive medium and a spot forming apparatus. A light source emits a laser beam, a rotary polygonal mirror reflects light from the light source while being rotated, f-θ lenses cause the light reflected from the rotary polygonal mirror to form a proper spot, and a reflecting mirror disposed on an optical path between the f-θ lenses and the photosensitive medium directs the spot toward the photosensitive medium. The slit plate passes a portion of the spot to uniformly form the scan line.

### CROSS REFERENCE TO RELATED APPLICATIONS

This application claims the benefit of Korean Application No. 2000-61984, filed Oct. 20, 2000 in the Korean Patent Office, the disclosure of which is incorporated herein by reference.

### BACKGROUND OF THE INVENTION

1. Field of the Invention

The present invention relates to an optical scanning apparatus, and more particularly, to an optical scanning apparatus which is improved in color registration by reducing bow of a scan line by using a plate provided with a slit having a width appropriate for the spot size of the scan line, and a length corresponding to a predetermined scanning length.

2. Description of the Related Art

An optical scanning apparatus is an apparatus which is employed in a printing apparatus so as to scan, for example, a laser beam on a photosensitive medium such as a photosensitive belt and to form an electrostatic latent image. In addition, as demand for black and white printing is increasingly changed to demand for color printing, concern about a scanning apparatus employed in a color printer is increased. In such a color printing apparatus, scanning apparatuses corresponding to four colors, i.e., Y (yellow), M (magenta), C (cyan), and BK (black) are provided.

Referring to FIG. 1, a general optical scanning apparatus 200 includes a light source 100, a rotary polygonal mirror 105 which reflects light from the light source 100 while being rotated by a motor (not shown), f-θ lenses 115 which cause the light reflected by the rotary polygonal mirror 105 to form a proper spot along a scan line 113 on a photosensitive medium, for example a photosensitive belt 110, and a reflecting mirror 120, disposed on an optical path between the f-θ lenses 115 and the photosensitive belt 110, the reflecting mirror 120 reflecting incident light so that a path of the light passing through the f-θ lenses 115 is formed toward the scan line 113 on the photosensitive belt 110.

A collimating lens 122 which changes incident light into collimated light and a cylindrical lens 135 which converges the collimated light from the collimating lens 122 are disposed on an optical path between the light source 100 and the rotary polygonal mirror 105. A sensor 118 detects a starting point of the scan line 113. High-speed printing is performed by sequentially disposing four optical scanning apparatus configured as described above.

In the optical scanning apparatus 200, the light emitted from the light source 100 is changed into collimated light by the collimating lens 122. The collimated light passes through the cylindrical lens 135 and is reflected by the rotary polygonal mirror 105. After the light reflected by the rotary polygonal mirror 105 passes through the f-θ lenses 115, the path of the light which has passed through the f-θ lenses is changed by the reflecting mirror 120 so that a spot is formed at predetermined points of the scan line 113 on the photosensitive belt 110. The light source 100 is controlled to turn on and off together with the spot formation process to form an electrostatic latent image on the photosensitive belt 110.

However, a scan line which is formed by light beams which are emitted from the light source 100, pass through the rotary polygonal mirror 105, and are reflected by the reflecting mirror 120, is not formed as a straight scan line DL but is formed as a bowed scan line CL, as shown in FIG. 2. An amount of bowing of the scan line occurs depending on preciseness in manufacturing the rotary polygonal mirror 105 and the f-θ lenses 115, and additional bowing may occur depending on an arrangement of optical components.

FIG. 3 is a graph of curves illustrating variations in measured bow values according to lengths of scan lines in a conventional optical scanning apparatus. As shown in FIG. 3, the curves exhibit great deviation in bow. The variations in bow values represent differences between measured bow values and predetermined reference bow values. According to FIG. 3, a maximum value (point a) and a minimum value (point b) of variations in bow values exhibit a difference between the maximum and the minimum values of approximately 100 μm.

Where variations in bow values become greater, more errors in image formation take place, and printing performance of a printing apparatus deteriorates. That is, since four scanning apparatus are sequentially disposed in a color printer, and scanning operations are performed to form disagreeing scan lines where deviation in bow becomes greater in each scanning apparatus, color registration deteriorates markedly. However, errors in image formation due to difference in variations in bow values are not a problem that is solved by adjusting a mechanism of a conventional optical scanning apparatus.

A method of indirectly solving the bowing problem is to manufacture a scanning apparatus according to a specification wherein an amount of bow is small. A bow value in a general specification is ±0.2 mm, and where the bow value is made smaller, manufacturing cost of the scanning apparatus increases. Another method of solving the bow variation problem among the individual scanning apparatuses is to select components exhibiting similar bow shape and magnitude. However, components exhibiting similar characteristics must be selected from among manufactured components. Selecting and matching components is disadvantageous in mass-production and assembly. Since there is a limitation in which a scanning apparatus may be assembled by selecting components exhibiting similar characteristics, the selecting of components is not a practical solution.

### SUMMARY OF THE INVENTION

To solve the above problems, it is an object of the present invention to provide an optical scanning apparatus which achieves improved color registration by passing a light beam through a slit so as to make an amplitude of scan line bow constant.

Additional objects and advantages of the invention will be set forth in part in the description which follows, and, in part, will be obvious from the description, or may be learned by practice of the invention.

Accordingly, to achieve the above and other objects, there is provided an optical scanning apparatus comprising: a light source which emits a laser beam; a rotary polygonal mirror which reflects light from the light source while being rotated by a motor; f-θ lenses which cause the light reflected from the rotary polygonal mirror to form a proper light spot along a scan line on a photosensitive medium; a reflecting mirror, disposed on an optical path between the f-θ lenses and the photosensitive medium, which reflects incident light so that the path of the light passing through the f-θ lenses is directed toward the scan line on the photosensitive medium; and a plate having a slit interposed between the photosensitive medium and the reflecting mirror so that a shape of bow of the scan line is formed uniformly where the laser beam passes through the slit. Preferably, the slit has a length corresponding to a length of the scan line and the plate is disposed to be close to the photosensitive medium.

In addition, to achieve the above and other objects of the invention, there is provided an optical scanning apparatus comprising: a light source which emits a laser beam; a rotary polygonal mirror which reflects light from the light source while being rotated by a motor; f-θ lenses which cause the light reflected by the rotary polygonal mirror to form a proper spot along a scan line on a photosensitive medium; a reflecting mirror, disposed on an optical path between the f-θ lenses and the photosensitive medium, which reflects incident light so that a path of light passing through the f-θ lenses is directed toward the scan line on the photosensitive medium; a plate having a slit interposed between the photosensitive medium and the reflecting mirror so that a shape of bow of the scan line is formed uniformly where a laser beam passes through the slit; and a position adjusting unit which adjusts a position of the slit.

The position adjusting unit comprises: a transparent plate on which an image defining the slit is printed; holders provided at both sides of the transparent plate which support the transparent plate; and a position adjuster which is adapted to adjust a position of the slit relative to the photosensitive medium. The transparent plate is made of a suitable optical material, such as for example, glass.

### BRIEF DESCRIPTION OF THE DRAWINGS

The above objects and advantages of the present invention will become more apparent by describing in detail preferred embodiments thereof with reference to the attached drawings in which:

FIG. 1 is a perspective view illustrating a conventional optical scanning apparatus;

FIG. 2 is a schematic diagram illustrating scan line bow occurring where the conventional optical scanning apparatus is employed;

FIG. 3 is a graph illustrating variations in measured scan line bow values according to lengths of scan lines in the conventional optical scanning apparatus;

FIG. 4 is a schematic diagram illustrating an optical scanning apparatus according to the present invention;

FIG. 5 is a perspective view illustrating a portion of the optical scanning apparatus according to the present invention;

FIG. 6A is a diagram illustrating a relationship between a slit plate and a downward bulging bow in an optical scanning apparatus according to the present invention;

FIG. 6B is a diagram illustrating a relationship between a slit plate and an upward bulging bow in an optical scanning apparatus according to the present invention;

FIG. 7 is a diagram illustrating relationship between a slit and a beam in an optical scanning apparatus according to the present invention;

FIG. 8 is an exploded perspective view illustrating a first embodiment of a position adjusting unit of an optical scanning apparatus according to the present invention;

FIG. 9 is a schematic diagram illustrating a second embodiment of a position adjusting unit of an optical scanning apparatus according to the present invention; and

FIG. 10 is a schematic diagram illustrating a third embodiment of a position adjusting unit of an optical scanning apparatus according to the present invention.

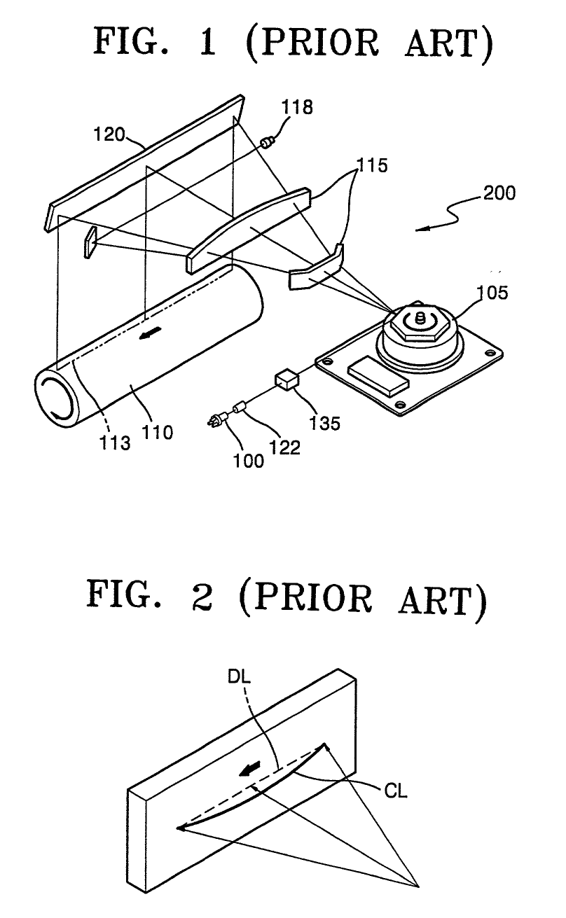

### DESCRIPTION OF THE PREFERRED EMBODIMENTS

Reference will now be made in detail to the present embodiments of the present invention, examples of which are illustrated in the accompanying drawings, wherein like reference numerals refer to like elements throughout.

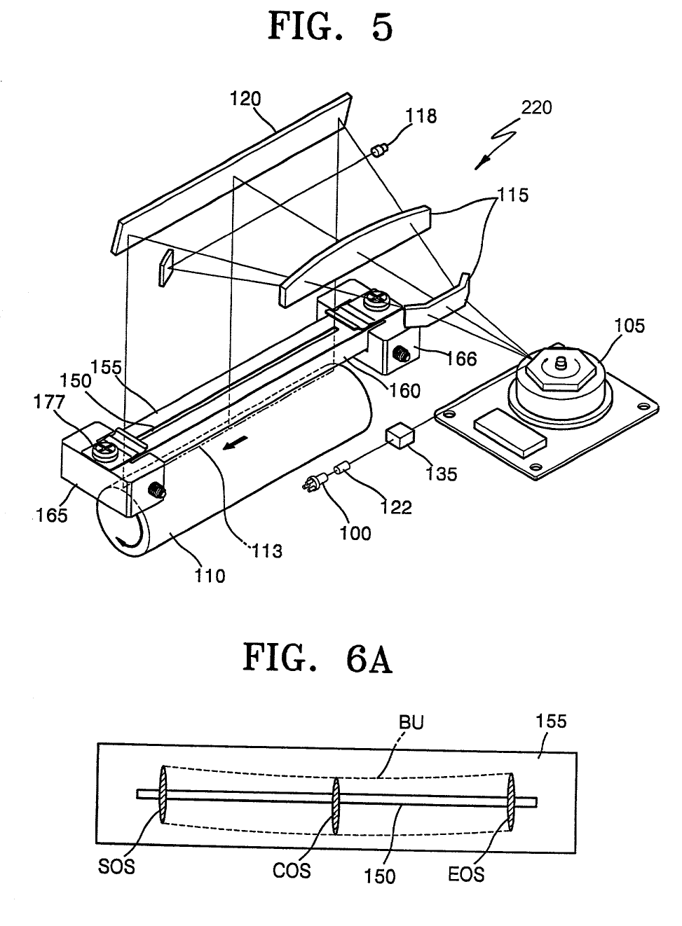

Referring to FIG. 4, an optical scanning apparatus according to the present invention is illustrated. The apparatus shown in FIG. 4 comprises a plurality of optical scanning units 220. Referring now to FIG. 5, in each optical scanning unit 220, a light source 100 emits light and a collimating lens 122 and a cylindrical lens 135 converge the light beam emitted from the light source 100. A rotary polygonal mirror 105 reflects the converged beam and f-θ lenses 115 cause the beam reflected by the rotary polygonal mirror 105 to form respective appropriate spots on a scan line 113 on a photosensitive medium 110, such as for example, a photosensitive belt. A reflecting mirror 120 disposed on an optical path between the f-θ lenses 115 and the photosensitive medium 110 reflects an incident beam so that a path of the light passing through the f-θ lenses 115 is directed toward the scan line 113 on the photosensitive medium 110. In the optical scanning unit 220, a plate 155 having a slit 150 is disposed between the reflecting mirror 120 and the photosensitive medium 110. In the embodiment shown in FIG. 4, four of the above optical scanning units 220 are sequentially disposed to scan the photosensitive medium 110, and in particular, the plate 155 is disposed to be close to the photosensitive medium 110.

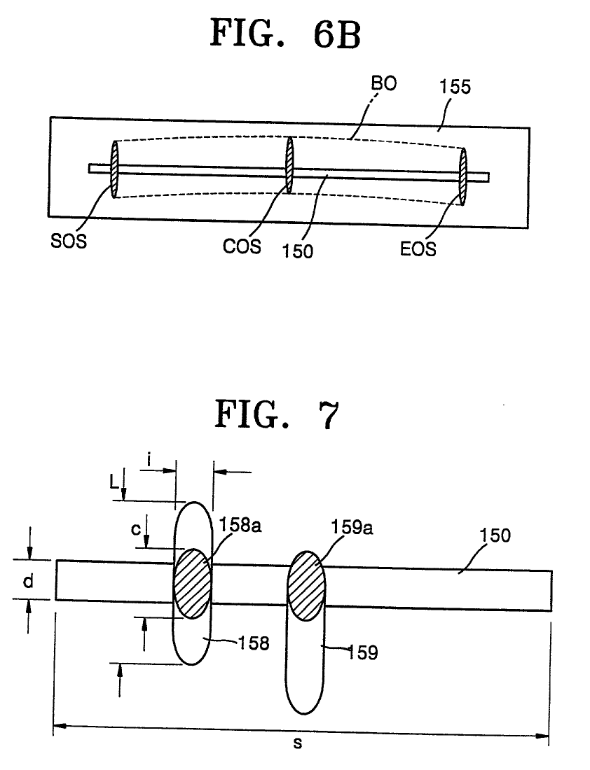

A scan line comprises a plurality of laser beam spots which are directed toward and distributed along the scan line. In FIGS. 6A and 6B, a starting laser beam spot of a scan line is referred to as SOS, a center laser beam spot is referred to as COS, and an end laser beam spot is referred to as EOS. The center laser beam spot COS may be positioned at an upside or a downside with respect to the line segment joining the spots SOS and EOS. Where the spot COS is positioned at an upside, the bow is referred to as an upward bulging bow (BO), and where the spot COS is positioned at a downside, the bow is referred to as a downward bulging bow (BU). Referring to FIG. 7, a width d of the slit 150 is determined so that a portion of all of the beams included in a scan line having a shape such as the upward bulging bow (BO) or the downward bulging bow (BU) passes through the slit 150. Thus, since a scan line is formed on the photosensitive medium 110 according to the shape of the slit 150 by the portion of the laser beam passing through the slit 150, the scan line is uniformly patterned.

The slit 150 is arranged to have a length s corresponding to a length of the scan line 113. Thus, after the laser beam is reflected from the reflecting mirror 120, a portion of the laser beam passes through the slit 150, and immediately forms a spot on the photosensitive medium 110.

The width d of the slit 150 is determined depending on the dimensions of the scan line 113, the size of a spot to be formed on the photosensitive medium 110, the size of a laser beam, and the like. Referring to FIG. 7, a width of a laser beam 158 measured in a direction along the length of the slit is referred to as an in-scan length i. A length of the laser beam 158 measured in a direction transverse to the length of the slit is referred to as a length L. A length of a spot 158a formed by the laser beam and passing through the slit 155 onto the photosensitive medium 110 is referred to as a cross-scan length c and is also measured in a direction transverse to the length of the slit. Laser beam 159 and spot 159a have similar dimensions as laser beam 158 and 158a respectively. Here, the cross-scan length c is an important factor in determining the width d of the slit 150.

The cross-scan length c is affected by various factors. For example, where a distance between the slit 150 and the photosensitive medium 110 increases, greater diffraction occurs, and the cross-scan length c of the spots 158a and 159a becomes greater. In addition, the cross-scan length c is affected by a position of the laser beam passing through the slit 150. That is, a center portion of the laser beam 158 is affected less by diffraction when passing through the slit 150 than a peripheral portion of the laser beam 159. Thus, the cross-scan length c of the laser beam 158 is shorter than the cross scan length c of the laser beam 159.

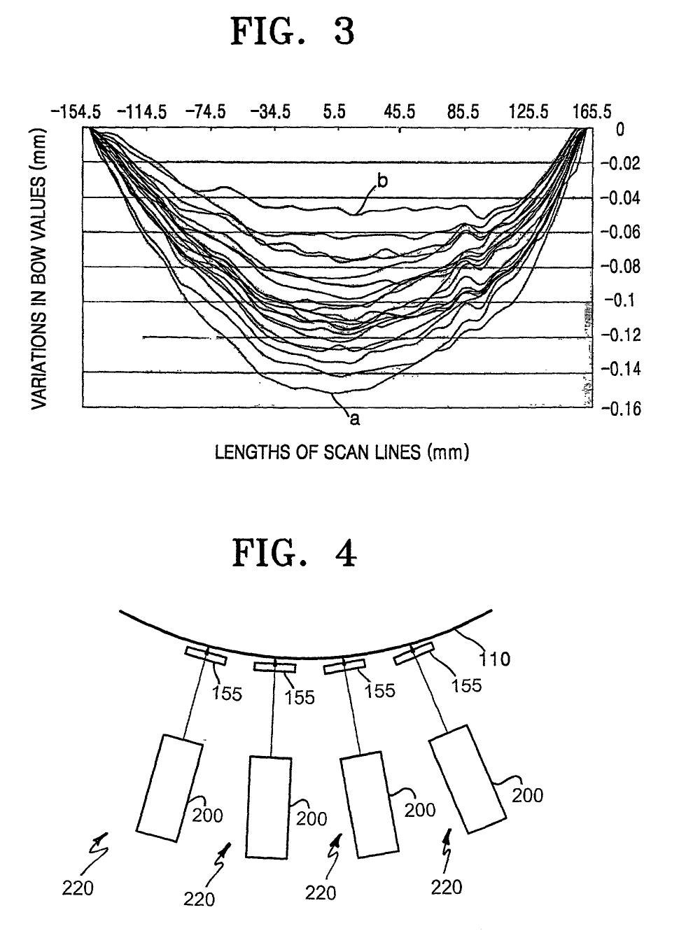

In general, in the case of a 600 dpi (dot per inch) printer, the laser beam spot is preferably about 75×85 μm. Then, assuming a greatest deviation of bow is 100 μm, beams of all ranges including a beam having the greatest possible deviation of bow pass through the slit where a size of a laser beam is 75×300 μm. In order to explain this, sections of beams of two points a and b shown in FIG. 3, which exhibit a maximum difference in deviation of bow, are shown in FIG. 7. Here, since the cross-scan length is 75 μm, and the maximum bow value at the point a is 150 μm, it follows that the length L of the laser beam 158 and 159 is at least about 225 μm. Preferably, the length L of the laser beam 158 (159) is about 300 μm in consideration of the intensity of the laser beam as well as the greatest possible deviation of bow. Thus, a scan line formed on the photosensitive medium 110 after the laser beam passes through the slit 150 will be a straight line.

Preferably, the plate 155 is installed close to the photosensitive medium 110 so that the effect of diffraction occurring as the laser beam 158 (159) passes through the slit 150 is minimized. In addition, since a degree of diffraction occurrence varies with the position of the beam passing through the slit 150, it is preferable that a center portion of the beam passes through the slit 150. Therefore, an optical scanning apparatus according to the present invention is also provided with a position adjusting unit adapted to adjust a position of the slit so that skew is adjustable, and the center portion of the laser beam passes through the slit.

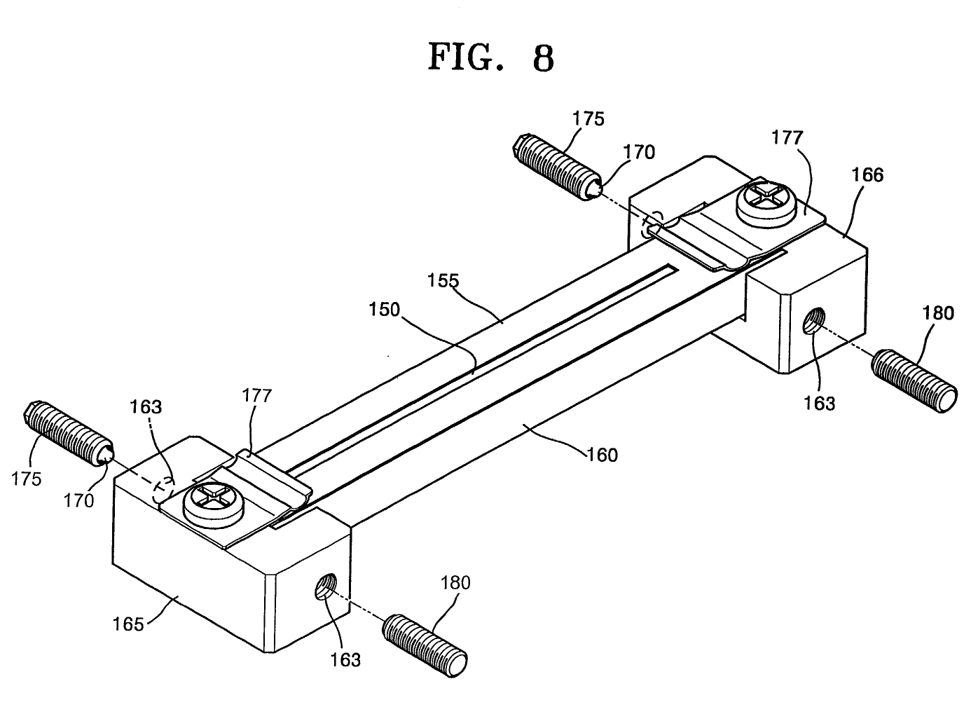

Referring to FIG. 8, in the position adjusting unit, the plate 155 comprises a transparent plate 160 having the slit 150 printed thereon and the transparent plate 160 is inserted into first and second holders 165 and 166 and supported by the first and second holders 165 and 166. In addition, a position adjuster which is adapted to reach the transparent plate 160 through holes 163 formed through at least one of the first and second holders 165 and 166 and to adjust a position of the plate 155 is provided at the holder(s) 165 and 166.

The position adjuster is formed at at least one of the first and second holders 165 and 166 by joining a ball plunger 175 having, at the inner end portion thereof, a ball 170 which is elastically biased by an elastic member (not shown), to a first of holes 163 formed in the first and second holders 165 and 166, and joining a set screw 180 to a second of the holes 163 opposite the first hole 163. Here, where the set screw 180 is loosened or tightened, the position of the transparent plate 160 is adjusted while the ball plunger 175 is elastically extended or retracted.

Alternatively, the position adjuster is formed by joining set screws 180 to both of the holes 163 of at least one of the first and second holders 165 and 166. Here, where one of the set screws 180 is tightened and the other set screw 180 is loosened, the position of the slit 150 is adjusted. The transparent plate 160 is elastically fixed to the holders 165 and 166 by respective plate springs 177.

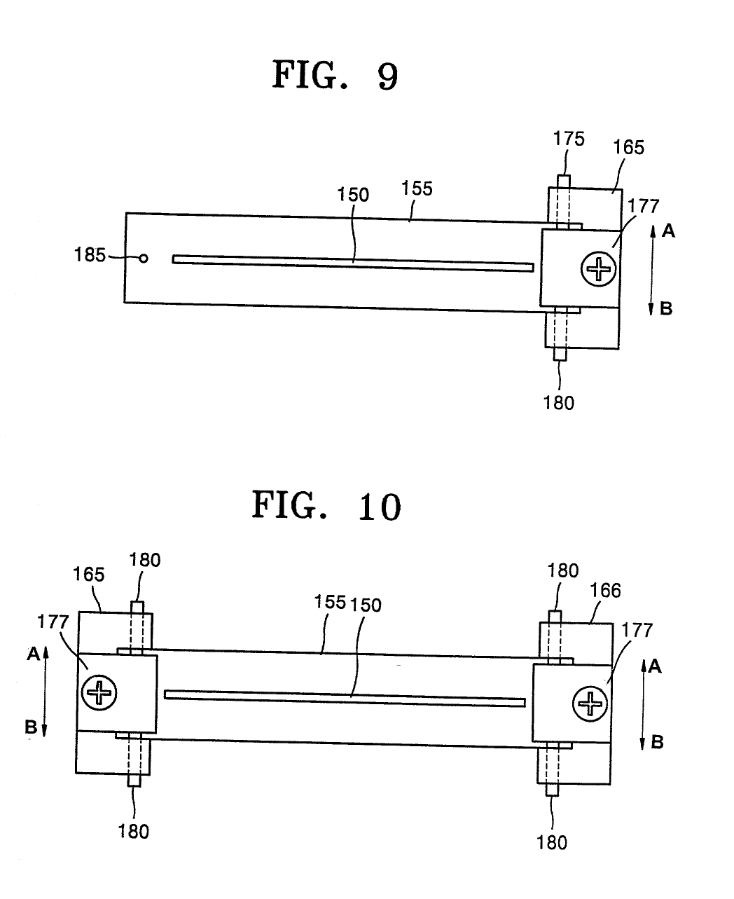

Alternatively, the position adjusting unit is configured as shown in FIG. 9, where one end of the transparent plate 160 is pivoted on a pivot shaft 185, and a ball plunger 175 and a set screw 180, or a pair of the set screws 180 are joined to the holder 165 at an end of the glass plate 160 opposite the pivot shaft 185. Thus, where the ball plunger 175 is used and the set screw 180 is tightened or loosened or where a pair of set screws 180 are used and the set screws 180 are adjusted, the transparent plate 160 is pivoted around the pivot shaft 185 so that skew of a scan line is adjusted by orientation of the slit 150.

Alternatively, as shown in FIG. 10, two position adjusters are provided. One position adjuster is provided at each end of the transparent plate 160 so that the position of the slit 150 is adjustable at both ends. In this case, each position adjuster comprises a ball plunger 175 and a set screw 180, or a pair of the set screws 180. With the position adjuster, a distance between scan lines is uniformly controllable, and a center of a beam is adjustable to pass through the slit so that intensities of spots are uniform. The arrows shown in FIGS. 9 and 10 and labeled A and B indicate directions of position adjustment of the slit. As described above, various position adjusting units are configured according to the present invention.

With the present invention, color registration is enhanced by reducing bow of a scan line in a simple manner by using a plate having a slit. Further, since an existing optical scanning unit may be utilized as it is, the present invention may be realized by additionally installing only a plate having a slit according to the present invention in a conventional unit. Thus, the object of the present invention may be attained without much cost increase.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An optical scanning apparatus for a photosensitive medium, comprising:
a light source which emits light;
a rotary polygonal mirror which reflects the light from the light source while being rotated;
f-θ lenses which cause the light reflected by the rotary polygonal mirror to form a light spot;
a reflecting mirror, disposed on an optical path between the f-θ lenses and the photosensitive medium, which directs the light spot toward the photosensitive medium; and
a plate having a slit, the plate interposed between the photosensitive medium and the reflecting mirror so that a scan line is formed uniformly by a portion of the light spot passing through the slit.

2. The optical scanning apparatus as claimed in claim 1, wherein the slit has a length corresponding to a length of the scan line.

3. The optical scanning apparatus as claimed in claim 2, wherein a dimension of the spot measured transverse to the slit has a length within a range including 225 μm and 300 μm.

4. The optical scanning apparatus as claimed in claim 2, wherein the plate is disposed to be closer to the photosensitive medium than to the reflecting mirror.

5. The optical scanning apparatus as claimed in claim 1, wherein a dimension of the spot measured transverse to the slit has a length within a range including 225 μm and 300 μm.

6. The optical scanning apparatus as claimed in claim 1, wherein the plate is disposed to be closer to the photosensitive medium than to the reflecting mirror.

7. An optical scanning apparatus for a photosensitive medium, comprising:
a light source which emits light;
a rotary polygonal mirror which reflects the light from the light source while being rotated;
f-θ lenses which cause the light reflected by the rotary polygonal mirror to form a light spot;
a reflecting mirror, disposed on an optical path between the f-θ lenses and the photosensitive medium, which directs the light spot toward the photosensitive medium;
a plate having a slit interposed between the photosensitive medium and the reflecting mirror so that a scan line is formed uniformly by a portion of the light spot passing through the slit; and
a position adjusting unit which adjusts a position of the slit.

8. The optical scanning apparatus as claimed in claim 7, wherein the slit has a length corresponding to a length of the scan line.

9. The optical scanning apparatus as claimed in claim 8, wherein a dimension of the spot measured transverse to the slit has a length within a range including 225 μm and 300 μm.

10. The optical scanning apparatus as claimed in claim 8, wherein:
the plate comprises a transparent plate on which the slit is printed; and
the position adjusting unit comprises:
a plurality of holders which support the transparent plate, and
a position adjuster which is engaged with at least one of the plurality of holders and which adjusts a position of the slit with respect to the photosensitive medium.

11. The optical scanning apparatus as claimed in claim 10, wherein the position adjuster comprises:
an elastically biased ball plunger which presses against one side of the plate, and
a set screw which presses against an opposite side of the plate.

12. The optical scanning apparatus as claimed in claim 10, wherein the position adjuster comprises first and second set screws which press against opposite sides of the plate.

13. The optical scanning apparatus as claimed in claim 7, wherein a dimension of the spot measured transverse to the slit has a length within a range including 225 μm and 300 μm.

14. The optical scanning apparatus as claimed in claim 7, wherein:
the plate comprises a transparent plate on which the slit is printed; and
the position adjusting unit comprises:
a plurality of holders which support the the plate, and
a position adjuster which is engaged with at least one of the plurality of holders and which adjusts a position of the slit with respect to the photosensitive medium.

15. The optical scanning apparatus as claimed in claim 10, wherein the transparent plate is a glass plate.

16. The optical scanning apparatus as claimed in claim 1, wherein the plate comprises a transparent plate on which the slit is printed.

17. An optical scanning apparatus comprising:
an optical system which directs a light spot on a predetermined path toward a photosensitive medium; and
a plate having a slit interposed between the optical system and the photosensitive medium, the slit passing a portion of the light spot to uniformly form a scan line on the photosensitive medium.

18. The optical scanning apparatus as claimed in claim 17, wherein the plate comprises a transparent plate on which the slit is printed.

19. The optical scanning apparatus as claimed in claim 17, further comprising a position adjusting unit which adjusts a position of the slit with respect to the photosensitive medium.

20. The optical scanning apparatus as claimed in claim 17, wherein a ratio of a length of the light spot on the predetermined path to a length of the portion of the light spot passed to the photosensitive medium is greater than 1:1, where the lengths are measured transverse to a length of the slit.

21. The optical scanning apparatus as claimed in claim 20, wherein the ratio is about 4:1.

22. The optical scanning apparatus as claimed in claim 17, wherein the predetermined path is bow shaped.

23. The optical scanning apparatus as claimed in claim 22, wherein:
a length of the light spot on the predetermined path is greater than or equal to a sum of an amount of bow in the predetermined path and a length of the portion of the light spot passing through the slit, where the lengths are measured transverse to a length of the slit.

24. The optical scanning apparatus as claimed in claim 23, wherein:
where the length of the portion of the light spot passing through the slit is about 75 μm, the length of the length of the light spot is in a range including 225 μm and 300 μm.
